(19) United States
(12) Patent Application Publication
(10) Pub. No.: US 2007/0074259 A1
(43) Pub. Date: Mar. 29, 2007

(54) DATA RECORDING DEVICE, CONNECTING DEVICE, INFORMATION PROCESSING DEVICE, INFORMATION PROCESSING METHOD, AND INFORMATION PROCESSING SYSTEM

(75) Inventor: Kazuo Matsubara, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/534,517

(22) Filed: Sep. 22, 2006

(30) Foreign Application Priority Data
Sep. 28, 2005 (JP) P2005-282999

(51) Int. Cl. H04N 7/173

(52) U.S. Cl. 725/105

(57) ABSTRACT

A data recording device, a connecting device, an information processing device, and information processing method, and an information processing system. The data recording device to be detachably connected to an information processing device provided with display means, and for performing a writing operation and/or a readout operation of data, includes obtaining means for obtaining internal information including information of the display means in response to connection to the information processing device, generating means for generating graphical user interface (GUI) screen data to be displayed on the display means based on the internal information obtained by the obtaining means, and output means for outputting the GUI screen data generated by the generating means to the information processing device.

### CROSS REFERENCES TO RELATED APPLICATIONS

The present application claims priority to Japanese Patent application JP 2005-282999 filed in the Japanese Patent Office on Sep. 28, 2005, the entire contents of which being incorporated herein by reference.

### BACKGROUND

The present application relates to a data recording device for recording and reproducing data, a connecting device, an information processing device for processing data, to which a data recording device is detachably connected, and a processing method therefor, an information processing system composed of a data recording device and an information processing device connected to each other.

So-called removable media such as USB memory devices, portable hard disk drives (HDD), or semiconductor memory devices have widely spread because they can be carried with data stored in them.

In general, as shown in FIG. 20, a semiconductor memory device is configured including a host interface (I/F) 101 for communicating data with host equipment such as a computer device, a page buffer 102, a register 103, a flash memory 104, a flash memory I/F 105 for communicating data with the flash memory 104, a central processing unit (CPU) 106, and a CPU bus 107.

The data communicated via the host I/F 101 is temporarily stored in the page buffer 102 having a predetermined capacity to be converted into serial/parallel data. The register 103 watches the operation state of the flash memory 104 such as data writing or data erasing, or whether or not memory cells are in a lock-up state. The CPU 106 performs data transfer between the page buffer 102 and the flash memory 104 based on the register 103 in accordance with a command from the host equipment to control reading, writing, and erasing. According to the semiconductor memory device having such a configuration, the user can read out a desired file with other host equipment (see, for example, http://www.highmat.com/japanese/whatisit/).

However, when the removable medium such as the semiconductor memory device described above is inserted in or connected to the host equipment, the host equipment needs to read out file names for detecting the files in the removable medium and organize them as a file list to display it on a display screen as an initial operation, and moreover, this operation must be done every time the removable medium is connected thereto.

Further, as the storage capacity of the removable medium becomes larger and the number of files increases, the initial operation requires more time.

Further, when the file stored in the removable medium is displayed, the display format to the user is varied according to the host equipment, which the removable medium is inserted in or connected to. Therefore, the user must perform his or her own display setting for every host equipment.

Meanwhile, although it is known that by recording content data on, for example, a compact disc (CD) with a format called HighMATTM, a desired file recorded on the CD can be displayed or selected by, for example, a digital versatile disk (DVD) player, the initial operation thereof also requires much time. Further, the display format of the file has strong dependency on the host equipment to allow no freedom, and is not user-friendly.

### SUMMARY

The present disclosure addresses such an actual condition of the related art, and has an advantage of providing a data recording device, a connecting device, an information processing device, an information processing method, and an information processing system capable of reducing the initial operation time and displaying a file in a desired display format.

According to an embodiment, there is provided a data recording device to be detachably connected to an information processing device provided with display means, and for performing a writing operation and/or a readout operation of data, including obtaining means for obtaining internal information including information of the display means in response to connection to the information processing device, generating means for generating graphical user interface (GUI) screen data to be displayed on the display means based on the internal information obtained by the obtaining means, and output means for outputting the GUI screen data generated by the generating means to the information processing device.

Further, according to another embodiment, there is provided an information processing device to be detachably connected to a data recording device for performing a writing operation and/or readout operation of data, including display means for displaying a graphical user interface (GUI) screen corresponding to GUI screen data output from the data recording device.

Further, according to still another embodiment, there is provided an information processing method including the step of providing an information processing system including an information processing device provided with display means and a data recording device detachably connected to the information processing device and for performing a writing operation and/or a readout operation of data, the step of obtaining internal information including information of the display means in response to the data recording device being connected to the information processing device, the step of generating graphical user interface (GUI) screen data based on the internal information obtained in the obtaining step, the step of outputting the GUI screen data generated in the generating step from the data recording device to the information processing device, and the step of displaying the GUI screen corresponding to the GUI screen data output in the outputting step on the display means.

Further, according to another embodiment, there is provided an information processing system including an information processing device provided with display means, and a data recording device detachably connected to the information processing device and for performing a writing operation and/or a readout operation of data, wherein the data recording device includes obtaining means for obtaining internal information including information of the display means in response to connection to the information processing device, generating means for generating graphical user interface (GUI) screen data based on the internal information obtained by the obtaining means, and output means for outputting the GUI screen data generated by the generating means from the data recording device to the information processing device, and the information processing device includes display means for displaying a GUI screen corresponding to GUI screen data output from the data recording device.

Further, according to still another embodiment, there is provided a connecting device to be detachably connected to an information processing device provided with display means and to be detachably connected to a recording device for recording data, and for performing a writing operation and/or a readout operation of the data, including obtaining means for obtaining internal information including information of the display means in response to connection to the information processing device and to the recording device, generating means for generating graphical user interface (GUI) screen data to be displayed on the display means based on the internal information obtained by the obtaining means, and output means for outputting the GUI screen data generated by the generating means to the information processing device.

According to an embodiment, when the information processing device provided with the display means and the data recording device are connected to each other, the recording device obtains the internal information including the information of the display means, and generates the GUI screen data based on the internal information. Therefore, since it is sufficient for the information processing device to display the GUI screen obtained from the data recording device on the display means, the initial operation time can be shortened. Further, the files can be displayed with the display format unique to the data recording device and independent of the information processing device itself.

Additional features and advantages are described herein, and will be apparent from, the following Detailed Description and the figures.

### BRIEF DESCRIPTION OF THE FIGURES

FIG. 1 is a block diagram showing a configuration of an information processing system according to an embodiment of the invention.

FIG. 2 is a diagram showing an example of a layered structure of a communication protocol.

FIGS. 3A through 3E are diagrams for explaining the communication protocol.

FIG. 4 is a diagram for explaining attribute information of a file.

FIG. 5 is a diagram showing an example of organizing the files according to the attribute information.

FIG. 6 is a diagram showing an example of organizing the files according to the names thereof.

FIG. 7 is a diagram showing an example of a menu screen of the files categorized based on the attribute information.

FIG. 8 is a block diagram showing a configuration of a data recording device 2 according to an embodiment of the invention.

FIG. 9 is a chart for explaining an initial sequence according to an embodiment of the invention.

FIGS. 10A and 10B are diagrams showing an example of a menu screen according to an embodiment of the invention.

FIG. 11 is a chart for explaining an operation sequence according to an embodiment of the invention.

FIGS. 12A and 12B are charts for explaining an ending sequence according to an embodiment of the invention.

FIG. 13 is a chart for explaining a readout sequence (first part) according to an embodiment of the invention.

FIG. 14 is a chart for explaining the readout sequence (second part) according to an embodiment of the invention.

FIG. 15 is a chart for explaining a reproduction sequence according to an embodiment of the invention.

FIG. 16 is a chart for explaining a writing sequence according to an embodiment of the invention.

FIGS. 17A and 17B are diagrams showing an example of writing music data.

FIGS. 18A and 18B are diagrams showing an example of writing photographic data.

FIG. 19 is a block diagram showing a configuration of a connecting device according to an embodiment of the invention.

FIG. 20 is a block diagram showing a configuration of a data recording device 2 in the related art.

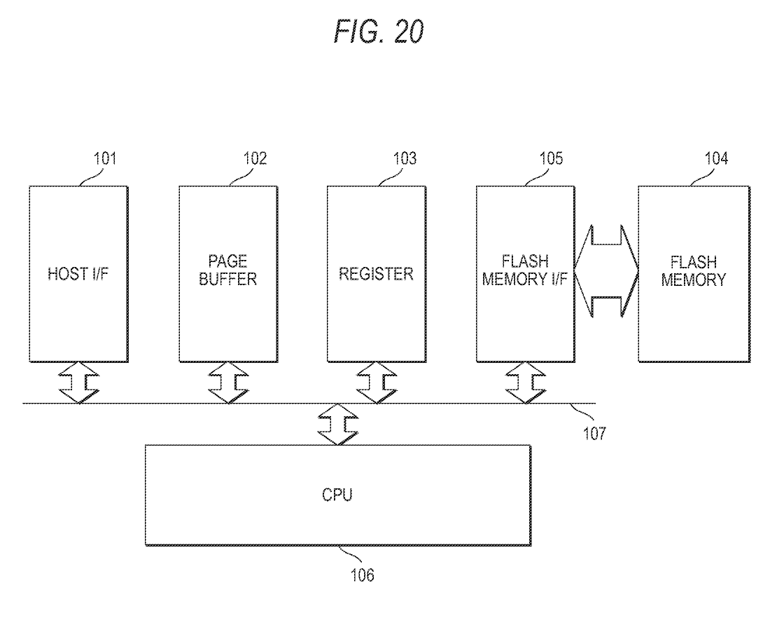

### DETAILED DESCRIPTION

A description in further detail with reference to the accompanying drawings follows.

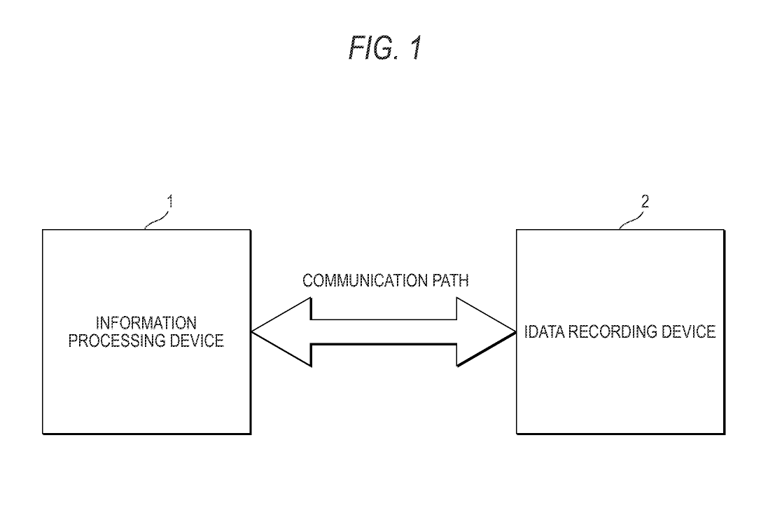

FIG. 1 is a block diagram showing a configuration of an information processing system according to an embodiment of the invention. The information processing system is composed of an information processing device 1 as the host equipment operated by the user, such as a portable music player, a digital camera, or a so-called personal computer, and a data recording device 2 connected to each other via a wired or wireless communication path.

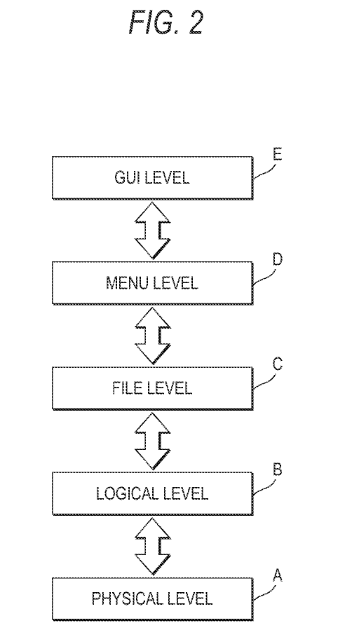

The communication protocol between the information processing device 1 and the data recording device 2 will be explained here with reference to FIGS. 2 through 8. The communication protocol can be divided into several levels, for example, a physical level A, a logical level B, a file level C, a menu level D, and a graphical user interface (GUI) level E as shown in FIG. 2.

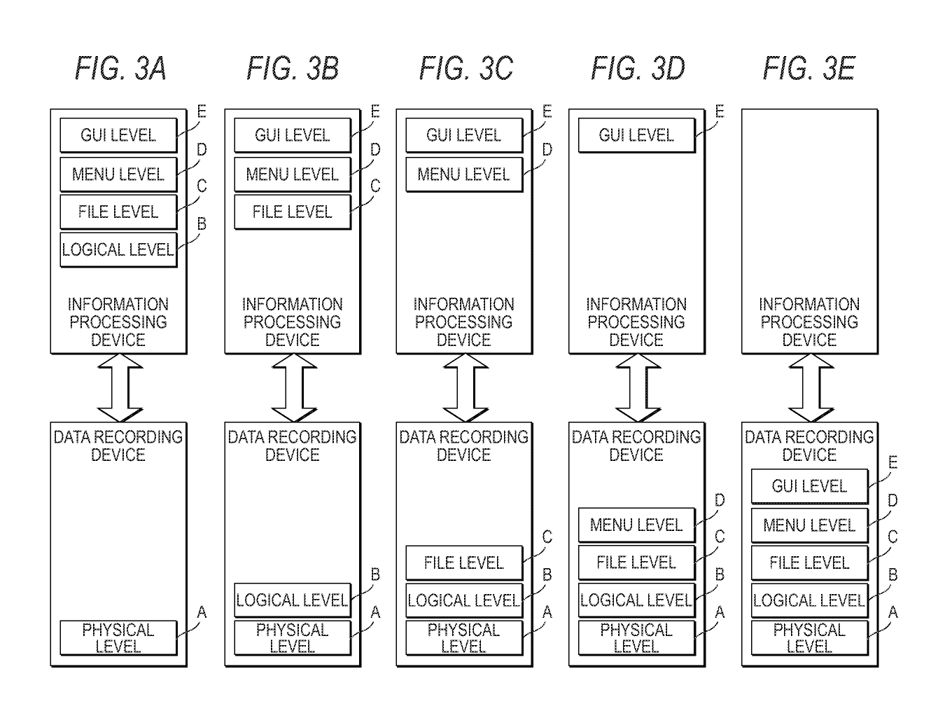

In the physical level A, a physical address representing a block in the device is used. If the information processing device 1 and the data recording device 2 communicate with each other in the physical level A as shown in FIG. 3A, the information processing device 1 needs to directly designate the physical address in the data recording device 2 at which the data is stored, which causes a heavy process load.

In the logical level B, a virtual address converted from the physical address to logically represent what is the number of the block is used. If the information processing device 1 and the data recording device 2 communicate with each other in the logical level B as shown in FIG. 3B, the information processing device 1 can increase the processing speed by using the virtual address compared to the case of directly designating the physical address.

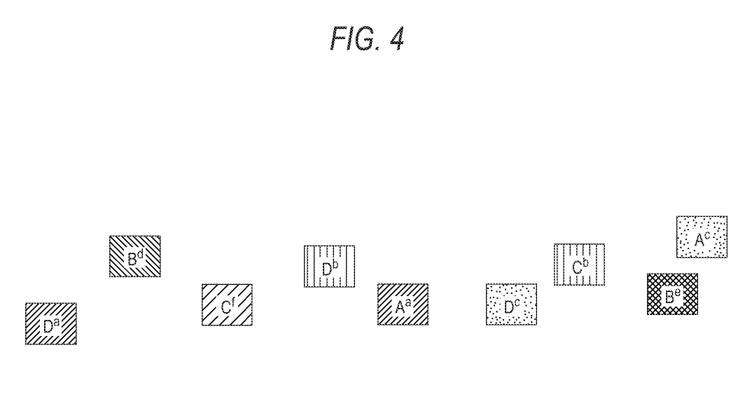

In the file level C, the allocation of the blocks composing the file such as a file allocation table (FAT) or a universal disk format (UDF) is controlled. If the information processing device 1 and the data recording device 2 communicate with each other via the file level C as shown in FIG. 3C, the information processing device 1 can perform the readout of the file and so on with the name of the file. Further, it can control the attribute information a through f of the files as shown in FIG. 4.

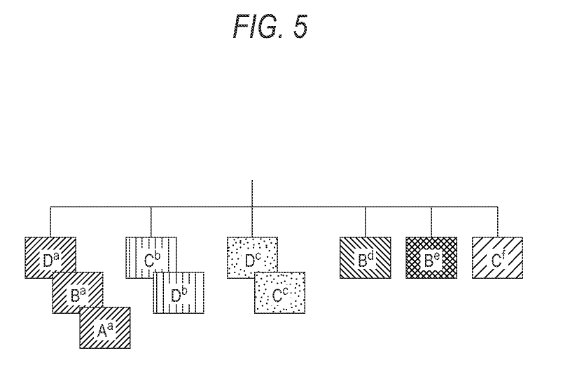

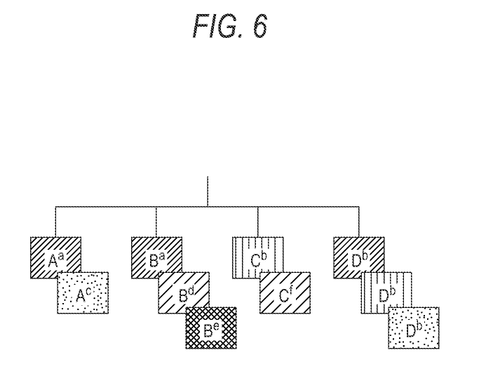

The menu level D relates to the logical structure of the menu reordered to be easy-to-read by the user based on the attribute information of the files. If the information processing device 1 and the data recording device 2 communicate with each other as shown in FIG. 3D, the information processing device 1 can generate a menu screen based on the logical structure of the menu created by the data recording device 2 such as a menu structure reordered by categories according to the attribute information of the files shown in FIG. 5 or a menu structure sorted by name shown in FIG. 6. In FIGS. 5 and 6, the alphabet capitals A through D denote file names while the lower-case letters a through f denote attribute information.

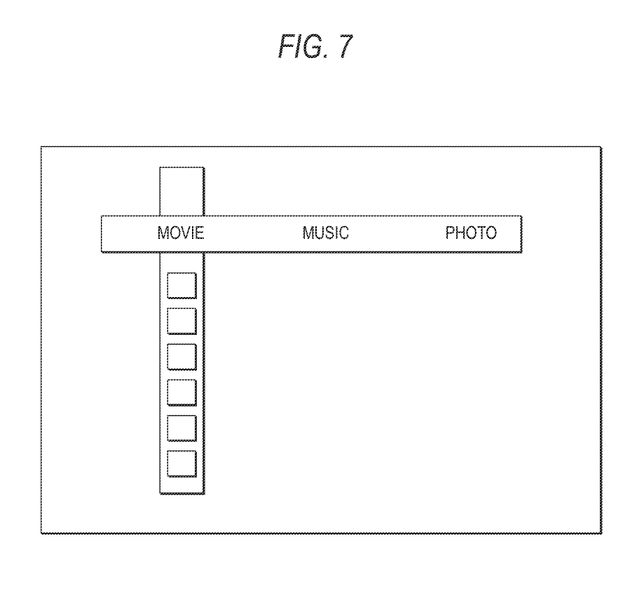

The GUI level E relates to generation of a GUI screen based on the logical structure of the menu. If the information processing device 1 and the data recording device 2 communicate with each other as shown in FIG. 3E, the information processing device 1 can display the GUI screen corresponding to the GUI screen data created by the data recording device 2. The GUI screen can provide the content of the data recorded in the data recording device 2 as, for example, the menu screen called Cross Media BarTM shown in FIG. 7 in which the files are divided into categories. Since in the information processing system according to the present embodiment, the data recording device 2 sends the GUI screen data as shown in FIG. 7 to the information processing device 1, it can be said that the communication protocol between the information processing device 1 and the data recording device 2 includes the GUI level E.

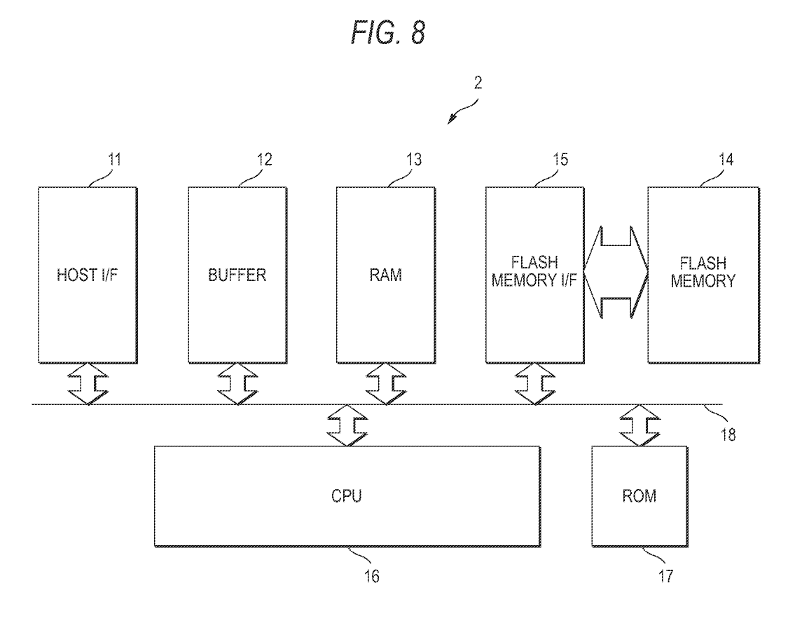

The configuration of the data recording device 2 according to an embodiment of the invention will now be explained. As shown in FIG. 8, the data recording device 2 is configured including a host I/F 11 for communicating data to the information processing device 1, a buffer 12, a random access memory (RAM) 13, a flash memory 14, which data can freely be removed from or stored to, a flash memory I/F 15 for allowing communication of data with the flash memory 14, a CPU 16, a read only memory (ROM) 17 for storing a program to be performed be the CPU 16, and a CPU bus 18.

Since the data recording device 2 according to the present embodiment communicates by the protocol including the GUI level, the CPU 16 for performing the sophisticated program stored in the ROM 17 and the RAM 13 are provided. Further, the flash memory 14 is a rewritable read only memory allowing the stored data to be electrically erased called a flash erasable programmable read only memory (flash EEPROM). It is a memory capable of providing high speed readout. Further, the buffer 12 is preferably a FIFO.

Further, the data communicated via the host I/F 11 is divided into three categories, namely screen/sound information, operation information, and control information.

The screen/sound information is screen data or sound data based on the GUI, and generated by performing the program with the CPU 16 and the RAM 13. More specifically, it is screen information such as a Windows Device-Independent Bitmap (BMP) file or sound information such as a WAV file.

Further, the operation information includes, for example, coordinates information of a pointer on the screen or information of a scroll operation or a button operation in accordance with a user operation in the information processing device 1.

Further, the control information is, for example, information instructing starting or ending of the protocol.

The information processing system according to the present embodiment uses these three kinds of data to perform every sequence.

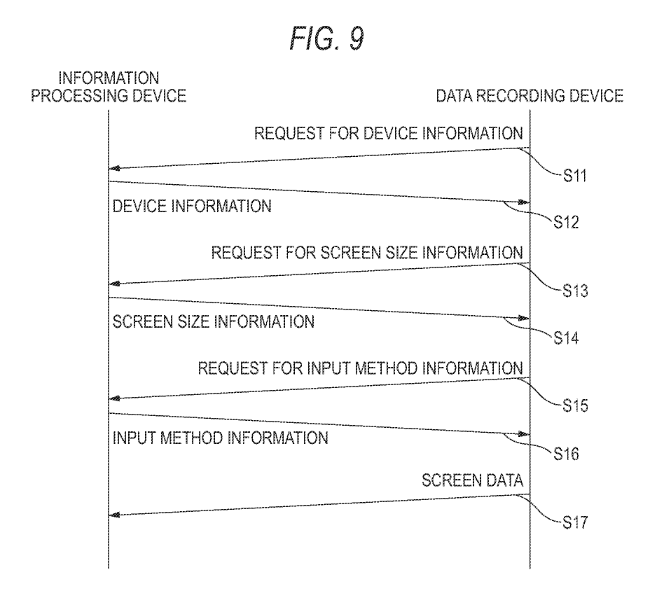

FIG. 9 is a chart for explaining an initial sequence in the information processing system. In response to connection to the information processing device 1, the data recording device 2 requests device information to the information processing device 1 (step S11). The device information represents species of the equipment, namely a category or a type of the information processing device 1 such as a digital camera, a mobile phone, or a video recorder. The information processing device 1 responds to the request for the device information (step S12).

Subsequently, the data recording device 2 requests screen size information to the information processing device 1 (step S13). Then, in response to the request, the information processing device 1 sends the screen size information to the data recording device 2 (step S14). The screen size information is information regarding a display section included in the information processing device 1, such as a quarter video graphics array (QVGA), a standard definition television (SDTV), or a high definition television (HDTV).

Subsequently, the data recording device 2 requests input method information to the information processing device 1 (step S15). Then, in response to the request, the information processing device 1 sends the input method information to the data recording device 2 (step S16). The input method information is information such as an arrow key for up, down, right, and left directions in digital cameras or mobile phones or a remote controller in video recorders.

In the step S17, the data recording device 2 creates the screen data in accordance with the internal information of the information processing device 1 obtained in the steps S11 through S16, and outputs it to the information processing device 1. The screen image data is for displaying the GUI screen, and the content of a file in the data recording device 2 can be displayed with a graphic image such as an icon.

As described above, by obtaining the internal information such as the device information, the input method information, or the screen size information, the data recording device 2 can accurately homologize the operation information in the x-axis direction or y-axis direction received from the information processing 1 with the GUI screen. Further, since the operation of reading out the file names in the data recording device 2 and organizing them as a file list to display in the screen performed as the initial operation is not necessary, the time required for the initial operation can be reduced. Further, since the screen data is created by the data recording device 2, the display format of the file does not depend on the information processing device 1, and accordingly, becomes user-friendly with freedom.

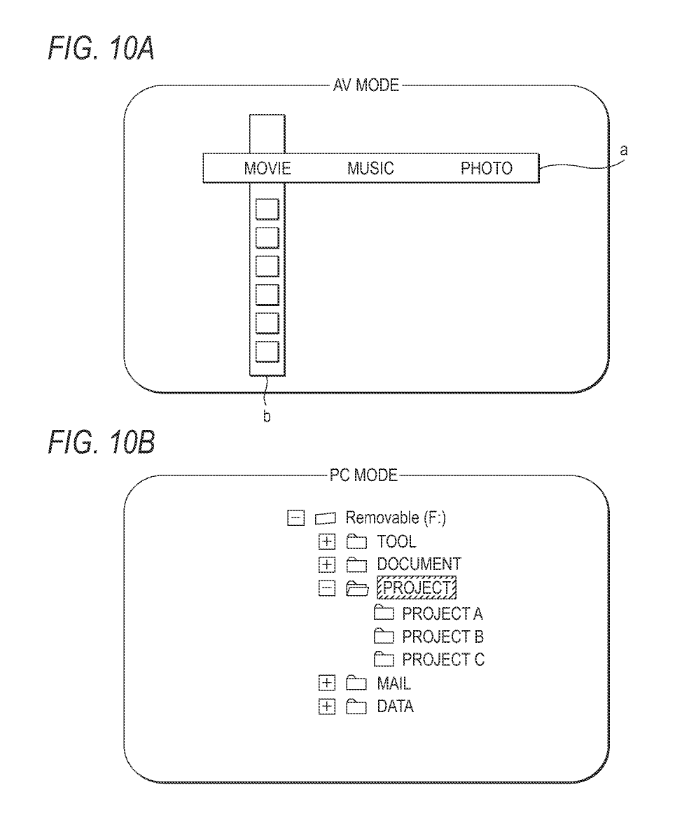

It should be noted that the screen data transferred in the step S17 preferably requires to select a method of displaying the files recorded on the data recording device 2. Thus, the user can select a display format such as an AV mode for dividing the files into categories or a PC mode for storing the files in predetermined hierarchical folders as shown in FIGS. 10A and 10B.

In this case, if the user selects the menu screen of the AV mode, the data recording device 2 divides the files into categories such as a movie, a music, or a photograph based on the attribute information recognized in the file level C, and creates the menu structure including a category bar a and a file bar b perpendicular to each other to generate the GUI screen data. Further, if, for example, the menu screen of the PC mode is selected, the data recording device 2 creates the menu structure provided with folders corresponding to items such as a tool, a document, a project, a mail, or data, respectively in which the files are stored hierarchically to generate the GUI screen data. Then, the GUI screen data generated by the data recording device 2 is sent to the information processing device 1, thus showing the files to the user in the desired display format.

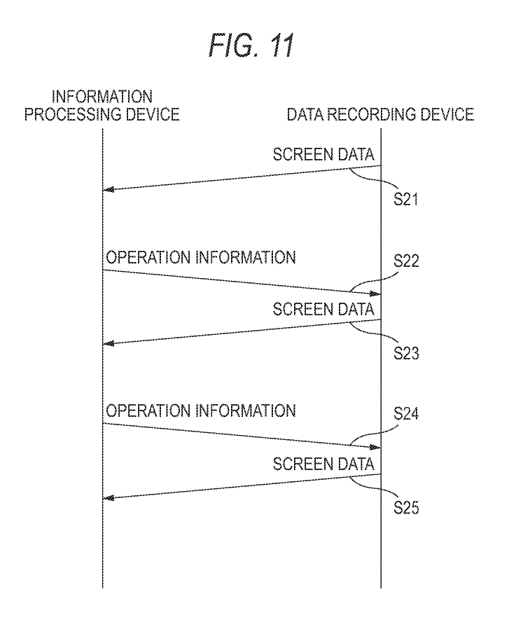

FIG. 11 is a chart for explaining the operation sequence of the information processing device 1 in accordance with the user operations. The data recording device 2 outputs the screen data to the information processing device 1 similarly to the step S17 in the initial sequence described above (step S21). The information processing device 1 then displays the GUI screen corresponding to the screen data obtained from the data recording device 2.

In this case, when the user performs, for example, a left-scroll operation in a certain GUI screen, the information processing device 1 creates left-scroll operation information to transmit it to the data recording device 2 (step S22). The data recording device 2 creates, for example, data of the scrolled screen in response to the operation information from the information processing device 1. The screen data is then sent to the information processing device 1 (step S23), and the GUI screen is displayed again on the screen of the information processing device 1.

Similarly to the above, when the user performs, for example, a file deletion operation, the information processing device 1 generates the operation information of file deletion, and sends it to the data recording device 2 (step S24). The data recording device 2 then recognizes from the operation information that the file deletion operation has been performed, and generates the screen data from which the file is deleted. The screen data is then sent to the information processing device 1 (step S25), and the GUI screen is displayed again on the screen of the information processing device 1.

As described above, since it is sufficient for the information processing device 1 to send the operation information corresponding to the operation input by the user to the data recording device 2 and to display the GUI screen in accordance with the screen information sent from the data recording device 2, the processing load can be reduced compared to the past. In other words, the data recording device 2 recognizes the user operation based on the user operation information sent form the information processing device 1 and the GUI screen data generated by the data recording device 2 itself, and performs a process such as data readout.

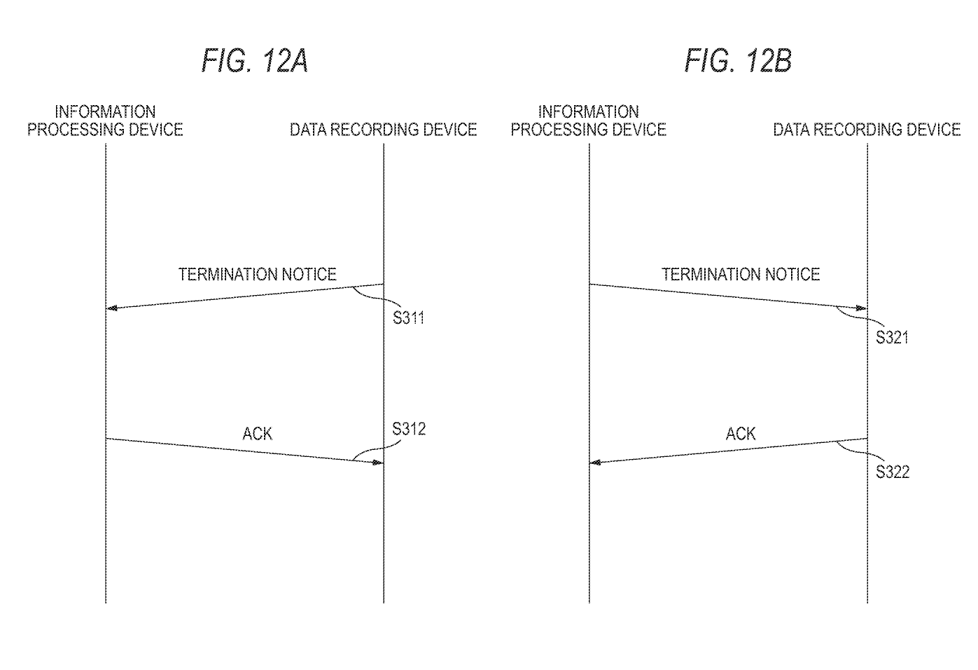

The ending sequence can be arranged to send a termination notice (step S311) from the data recording device 2 and to send back the response (ACKnowledgement) from the information processing device 1 as shown in FIG. 12A, or can be arranged to send the termination notice (step S321) from the information processing device 1 and to send back the response from the data recording device 2 as shown in FIG. 12B.

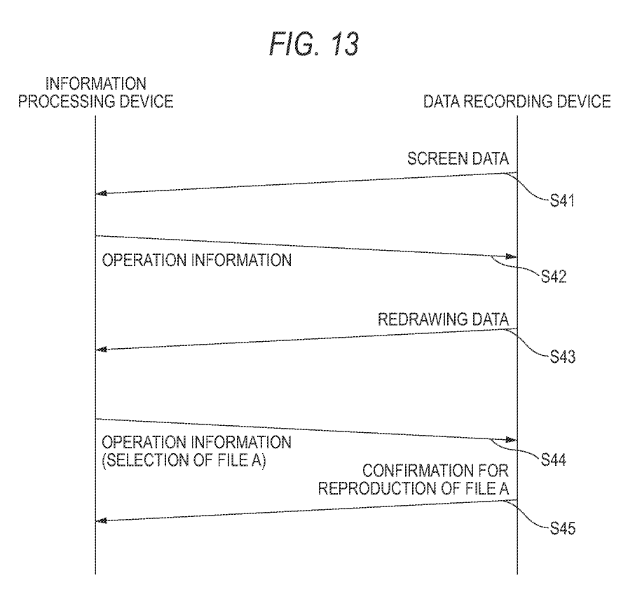

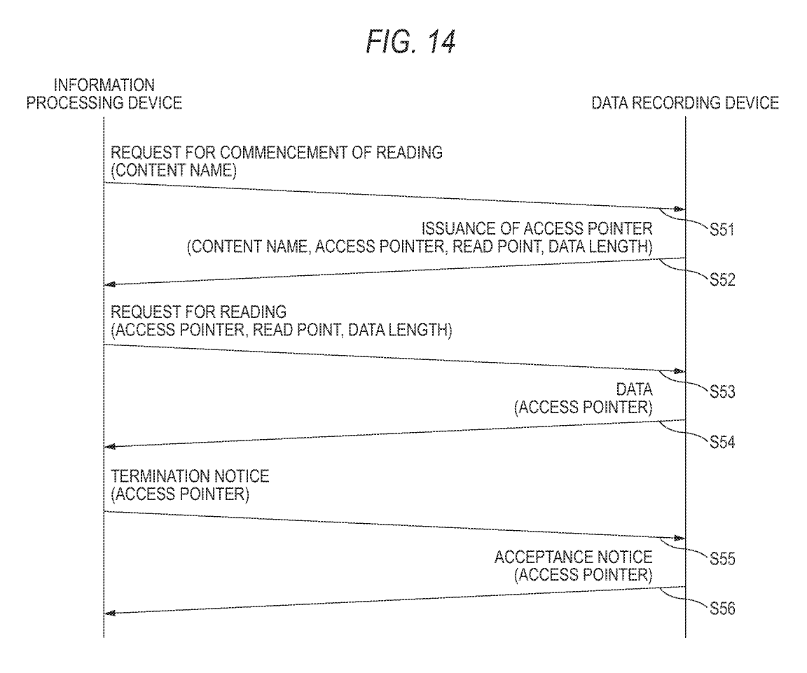

FIGS. 13 and 14 are charts for explaining a readout sequence in which the information processing device 1 reads out a file from the data recording device 2. Similarly to the operation sequence shown in FIG. 11, the data recording device 2 outputs the screen data to the information processing device 1 (step S41), generates the screen data in accordance with the operation information (step S42) from the information processing device 1, and sends it back to the information processing device 1 (step S43).

In this case, if, for example, the operation information of selecting and reproducing the file A is input from the information processing device 1 (step S44), the data recording device 2 confirms reproduction of the file A to the information processing device 1 (step S45). It should be noted that since the operation information does not include information regarding the file A, the information processing device 1 does not recognize at this moment that the file A has been selected. The information processing device 1 recognizes the selection of the file A from the request of the confirmation for reproduction of the file A, and discriminates whether or not the file can be reproduced. Specifically, whether or not the information processing device 1 itself has a codec for reproducing the file A is discriminated based on, for example, the extension of the file name. If it can be reproduced, a request for commencement of reading is sent to the data recording device 2 (step S51). This request for commencement of reading is performed by sending the name (A in the present embodiment) of the file to be read out.

The data recording device 2 issues an access pointer as an authority of accessing the file in response to the request for reading the file A, and sends it to the information processing device 1 (step S52). The access pointer makes it possible to, for example, access a number of files at a time.

In response to obtaining the access pointer, the information processing device 1 performs request for reading (step S53). In response to receiving the request for reading from the information processing device 1, the data recording device 2 reads out the data stored in a predetermined position in the flash memory 14 in accordance with a read point and data length obtained based on the operation information and the GUI screen, and sends it to the information processing device 1 (step S54). It should be noted here that the read point denotes information regarding what number of bytes in the data is read out, and the data length denotes information regarding how long data is read out.

It should also be noted that the data recording device 2 can also be arranged to read out the data stored at a predetermined position in the flash memory 14 in accordance with the request for reading the file A sent in the step S51, and to send the data to the information processing device 1.

When receiving all of the data in the file A, the information processing device 1 sends the termination notice to the data recording device 2 in the step S55, and the data recording device 2 sends an acceptance notice in response thereto (step S56).

As described above, since it is sufficient for the information processing device 1 to send the user operation information to the data recording device 2, a desired file can quickly be read out from the data recording device 2.

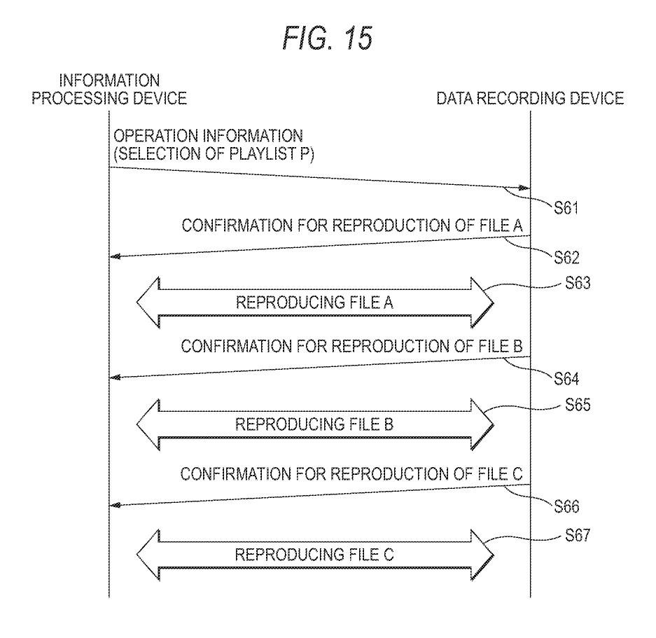

Further, in the case of program reproduction in which the user selects the playlist P, the information processing device 1 sends the operation information as shown in FIG. 15 (step S61). Based on the operation information, the data recording device 2 recognizes that the playlist P has been selected. Then, the confirmation for reproduction of the file A in the playlist P (step S62) is performed, and the processes of steps S51 through S56 described above are performed to reproduce the file A (step S63). Further, the same reproduction processes are performed for the file B, file C, and other files in the playlist P, respectively (steps S64 through S67). In other words, the data recording device 2 performs the confirmation for file reproduction in the order of the playlist P, and the information processing device 1 reproduces the files in the order of the request for confirmation of reproduction. Therefore, it can be said that the information processing device 1 does not know the fact that it performs reproduction of the files according to the playlist.

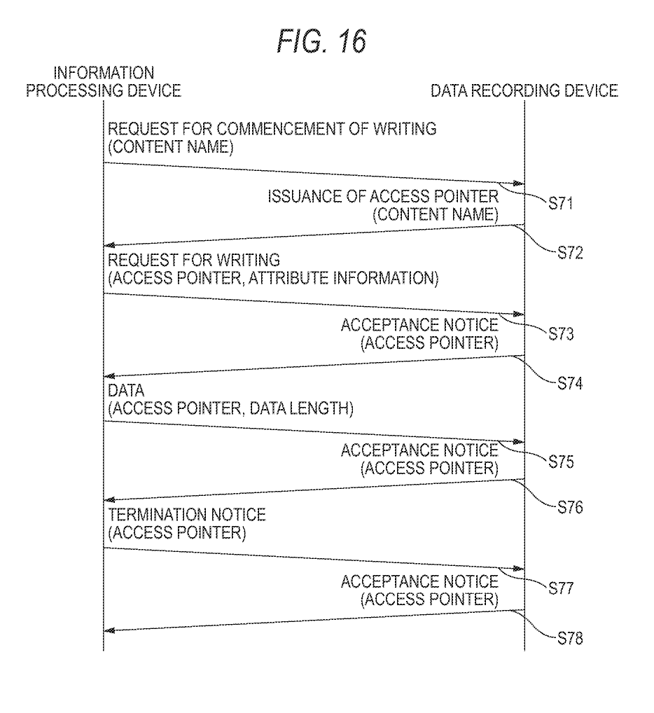

The writing sequence in the information processing system will hereinafter be described with reference to FIG. 16. In the step S71, the information processing device 1 performs a request for commencement of writing (step S71). It should be noted that the request for commencement of writing can be the operation information based on the GUI screen. In response to the request for commencement of writing, the data recording device 2 recognizes the name of the file to be written, and issues and sends the access pointer (step S72).

When receiving the access pointer, the information processing device sends to the data recording device 2 a writing request including attribute information of the file to be written (step S73). The attribute information includes meta-information such as a performer, a category, or recording date and hour, and information such as data length, extension, or a file name. The data recording device 2 determines what layer the file is recorded to based on the attribute information. After determining the recording position, the data recording device 2 sends the acceptance notice to the information processing device 1 (step S74).

In response to the acceptance notice, the information processing device 1 sends the data of the file to be written to the data recording device 2 (step S75). The data recording device 2 stores the data of the file to be written to the recording position determined based on the attribute information. After storing the data, the data recording device 2 sends the acceptance notice (step S76). The information processing device 1 sends the termination notice for representing termination of the data transmission (step S77), and receives the acceptance notice responsive there to from the data recording device 2 (step S78).

As described above, since the data recording device 2 designates the writing destination of the file, unlike the past, the processing load of the information processing device 1 can be reduced. Further, since the data recording device 2 manages the files, the files can be displayed with the display format set by the data recording device 2 regardless of the type of the information processing device 1.

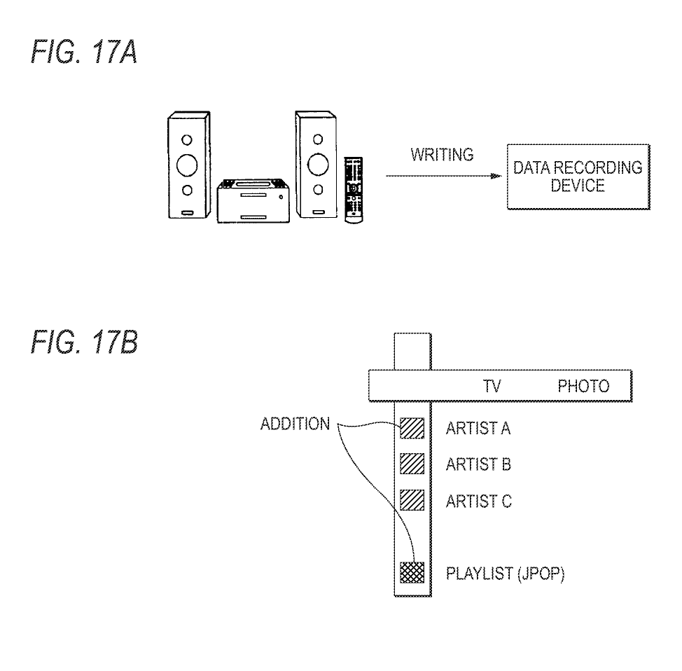

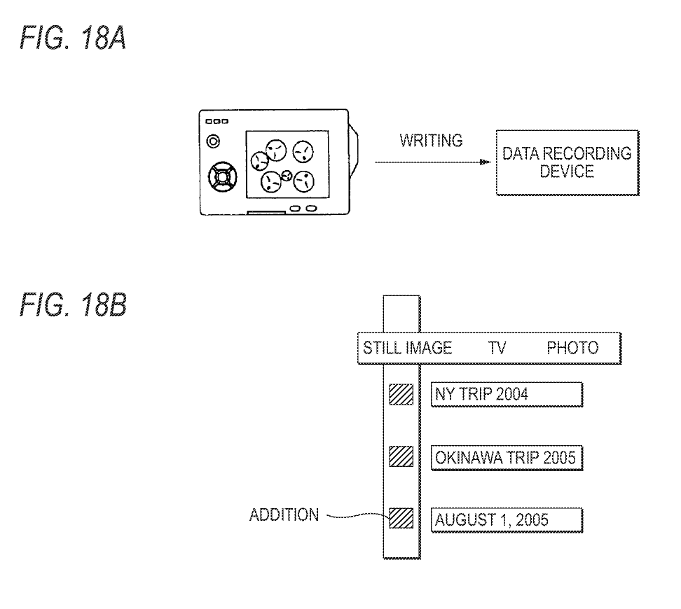

For example, in the case in which the information processing device 1 is a music player and music data of an artist A is written thereto as shown in FIG. 17A, “artist A” is added to an artist field, and also added in the “playlist”as in the menu shown in FIG. 17B. Further, in the case in which the information processing device 1 is, for example, a digital camera, and photographical data is written thereto as shown in FIG. 18A, the photograph is added in the folder of “Aug. 1, 2005” as in the menu shown in FIG. 18B. Since the data recording device 2 generates these menu screens, and manages all of the files, the information processing device 1 does not need to figure out the data recorded on the data recording device 2, thus the process load of the information processing device 1 can be reduced.

Further, since the data recording device 2 manages the files, in the case in which the free area of the flash memory 14 becomes small, for example, it is possible to automatically delete the files in the order corresponding to the lower access frequency to prepare the area for storing new files. Further, in the case in which, for example, the free area of the flash memory 14 becomes small, it is possible to show the user the files sorted in the order corresponding to the lower access frequency. Further, it is possible to show the status of use of the flash memory 14 regarding how much percentage of the capacity of the flash memory 14 is used for movie or music with, for example, a pie chart. Still further, it is possible to automatically move the file having no access for three months or more, for example, to the trash box. Since such settings can be performed for every data recording device 2 independently from the settings of the information processing device 1, the user can use the system at ease.

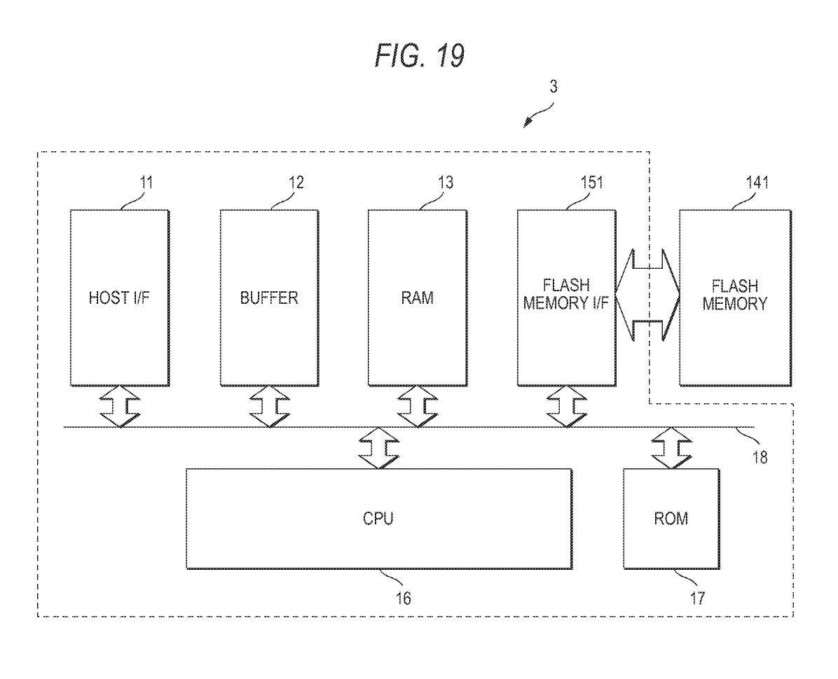

Although described above, the data recording device 2 as shown in FIG. 8 is used, a connecting device 3 as shown in FIG. 19 can also be used as another embodiment to reduce the process of the information processing device 1. It should be noted here that the same elements as those of the data recording device 2 shown in FIG. 8 are denoted with the same reference numerals, and detailed explanations therefor will be omitted.

The connecting device 3 is configured including the host I/F 11 for communicating data to the information processing device 1, the buffer 12, the RAM 13, a flash memory I/F 151 for communicating data to the flash memory 14, the CPU 16, the ROM 17 for storing a program to be performed be the CPU 16, and a CPU bus 18, and is detachably connected to the flash memory 141, which data can freely be removed from or stored to, via the flash memory I/F 151. According to such a configuration, the connecting device 3 is capable of generating GUI screen representing the data in the flash memory 141, and making the information processing device 1 display the files recorded in the flash memory 141.

Further, since it is sufficient for the information processing device 1 to display the GUI screen obtained from the connecting device 3 on the display section, the initial operation time can be shortened. Further, the files can be displayed with the display format unique to the flash memory 141 and independent of the information processing device 1 itself.

Further, the flash memory I/F 151 can be pursuant to the universal serial bus (USB), the Institute of Electrical and Electronics Engineers 1394(IEEE1394), and so on, and the host I/F 11 can be what is obtained by expanding these standards.

Further, although as described above, the configuration using the flash memory 14, 141 is adopted, other recording media such as an HDD can also be adopted.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A data recording device to be detachably connected to an information processing device provided with display means, and for performing a writing operation and/or a readout operation of data, comprising:
obtaining means for obtaining internal information including information of the display means in response to connection to the information processing device;
generating means for generating graphical user interface (GUI) screen data to be displayed on the display means based on the internal information obtained by the obtaining means; and
output means for outputting the GUI screen data generated by the generating means to the information processing device.

2. The data recording device according to claim 1,
wherein the GUI screen data is for displaying recording content of the data as a menu.

3. The data recording device according to claim 1,
wherein the obtaining means obtains user operation information from the information processing device, and
the generating means generates the GUI screen data in accordance with the user operation information.

4. The data recording device according to claim 1, further comprising
readout means for performing the readout operation,
wherein the obtaining means obtains the user operation information from the information processing device in the readout operation, and
the readout means reads out the data from a predetermined recording position based on the user operation information.

5. The data recording device according to claim 1, further comprising
writing means for performing the writing operation,
wherein the obtaining means obtains attribute information of the data from the information processing device in the writing operation, and
the writing means writes the data to a predetermined position based on the attribute information.

6. The data recording device according to claim 1, further comprising
managing means for managing recording capacity based on access frequency to the data in the readout operation.

7. The data recording device according to claim 1,
wherein the internal information includes information representing a type of the information processing device, information representing a screen size of the display means, and information representing an input method of input means provided to the information processing device.

8. An information processing device to be detachably connected to a data recording device for performing a writing operation and/or readout operation of data, comprising:
display means for displaying a graphical user interface (GUI) screen corresponding to GUI screen data output from the data recording device.

9. An information processing method comprising:
providing an information processing system including an information processing device provided with display means and a data recording device detachably connected to the information processing device and for performing a writing operation and/or a readout operation of data;
obtaining internal information including information of the display means in response to the data recording device being connected to the information processing device;
generating graphical user interface (GUI) screen data based on the internal information obtained in the obtaining step;
outputting the GUI screen data generated in the generating step from the data recording device to the information processing device; and
displaying the GUI screen corresponding to the GUI screen data output in the outputting step on the display means.

10. An information processing system comprising:
an information processing device provided with display means; and
a data recording device detachably connected to the information processing device and for performing a writing operation and/or a readout operation of data,
wherein the data recording device includes,
obtaining means for obtaining internal information including information of the display means in response to connection to the information processing device,
generating means for generating graphical user interface (GUI) screen data based on the internal information obtained by the obtaining means, and
output means for outputting the GUI screen data generated by the generating means from the data recording device to the information processing device, and
the information processing device includes,
display means for displaying a GUI screen corresponding to GUI screen data output from the data recording device.

11. A connecting device to be detachably connected to an information processing device provided with display means and to be detachably connected to a recording device for recording data, and for performing a writing operation and/or a readout operation of the data, comprising:
obtaining means for obtaining internal information including information of the display means in response to connection to the information processing device and to the recording device;
generating means for generating graphical user interface (GUI) screen data to be displayed on the display means based on the internal information obtained by the obtaining means; and
output means for outputting the GUI screen data generated by the generating means to the information processing device.

12. A data recording device to be detachably connected to an information processing device provided with a display, and for performing a writing operation and/or a readout operation of data, comprising:
an obtaining section that obtains internal information including information of the display in response to connection to the information processing device;
a generating section that generates graphical user interface (GUI) screen data to be displayed on the display based on the internal information obtained by the obtaining section; and
an output section that outputs the GUI screen data generated by the generating section to the information processing device.
